(19) United States
(12) Patent Application Publication
(10) Pub. No.: US 2019/0289341 A1
(43) Pub. Date: Sep. 19, 2019

(54) MEDIA OBJECT INSERTION SYSTEMS FOR PANORAMIC MEDIA

(71) Applicant: Eyesee, Lda, Lisbon (PT)

(72) Inventor: Joao Vasco de Oliveira Redol, Lisbon (PT)

(21) Appl. No.: 15/925,586

(22) Filed: Mar. 19, 2018

(51) Int. Cl. H04N 21/234; H04N 5/232; G06T 19/00; G02B 27/01; G06Q 30/02; G06N 3/08

(52) U.S. Cl. CPC H04N 21/23424; H04N 5/23238; G06N 3/08; G02B 27/017; G06Q 30/0241; G06T 19/006

(57) ABSTRACT

A method, system, apparatus, or device for inserting media object into panoramic media. The apparatus may include a memory device to store data in a database, a display device to display at least a portion of panoramic media, and a processing device coupled to the memory device and the display device. The processing device may analyze a 360-degree video to identify a first viable insertion area (VIA) within a first perspective window of the 360-degree video. The processing device may determine that the database includes a first media object that corresponds to the dimensions of the first VIA. The processing device may insert the first media object onto the panoramic media at the first VIA. The processing device may in response to the panoramic media ending, cease inserting the first media object onto the panoramic media at the first VIA.

### BACKGROUND

Advertisements (Ads) may be a major source of revenue for companies. There are many places for advertisers to promote a product or a service. For example, companies may advertise a product or a service in a magazine, in direct mailings, on television, in newspapers, or on the Internet. When advertising a product or a service, companies may desire to capture the attention of viewers by placing media objects where the media objects will be viewed without being intrusive or annoying the viewers, i.e. negatively affecting the image of the product or service being advertised.

To avoided intrusive or annoying advertisements, advertisers may integrate media object objects into images. For example, as videos continue to increase as a source of entertainment for viewers, integrating media objects into videos may provide an advertising platform for advertisers that is relatively non-intrusive and effective.

### SUMMARY

A method, system, apparatus, or device for inserting media object into panoramic media. The apparatus may include a memory device to store data in a database, a display device to display at least a portion of panoramic media, and a processing device coupled to the memory device and the display device. The processing device may analyze panoramic media to identify a viable insertion area (VIA) within a perspective window of the panoramic media. The processing device may determine that the database includes a media object that corresponds to the dimensions of the VIA. The processing device may insert the media object onto the panoramic media at the VIA. The processing device may in response to the panoramic media ending, cease inserting the media object onto the panoramic media at the VIA.

### BRIEF DESCRIPTION OF THE DRAWINGS

The present description will be understood more fully from the detailed description given below and from the accompanying drawings of various embodiments of the present embodiment, which is not to be taken to limit the present embodiment to the specific embodiments but are for explanation and understanding.

FIG. 1 illustrates a flowchart for a method to insert a media object into panoramic media, according to an embodiment.

FIG. 2A illustrates a panoramic display device displaying a first perspective window of panoramic media, according to an embodiment.

FIG. 2B illustrates the panoramic display device displaying a second perspective window of the panoramic media, according to an embodiment.

FIG. 3A illustrates a head-mounted display device displaying a first perspective window of panoramic media, according to an embodiment.

FIG. 3B illustrates the head-mounted display device displaying a second perspective window of the panoramic media, according to an embodiment.

FIG. 4A illustrates a display device displaying a first perspective window of panoramic media, according to an embodiment.

FIG. 4B illustrates the display device displaying a second perspective window of the panoramic media, according to an embodiment.

FIG. 5 illustrates an advertisement insertion system for inserting a media object into panoramic media, according to an embodiment.

FIG. 6 is a block diagram of a user device in which embodiments of the user device may be implemented in patient consent systems, according to an embodiment.

### DETAILED DESCRIPTION

The disclosed media object insertion systems for panoramic media will become better understood through a review of the following detailed description in conjunction with the figures. The detailed description and figures provide merely examples of the various embodiments described herein. Those skilled in the art will understand that the disclosed examples may be varied, modified, and altered and not depart from the scope of the embodiments described herein. Many variations are contemplated for different applications and design considerations; however, for the sake of brevity, the contemplated variations may not be individually described in the following detailed description.

Throughout the following detailed description, examples of various media object insertion systems for panoramic media are provided. Related features in the examples may be identical, similar, or dissimilar in different examples. For the sake of brevity, related features will not be redundantly explained in multiple examples. Instead, the use of related feature names will cue the reader that the feature with a related feature name may be similar to the related feature in an example explained previously. Features specific to a given example will be described in that particular example. The reader is to understand that a given feature need not be the same or similar to the specific portrayal of a related feature in any given figure or example.

Advertisers are continually seeking to promote their products or services in mediums viewed by potential customers. To increase the effectiveness of their advertisements (Ads), advertisers may insert their media objects in mediums that potential customers are engaged with and view for extended periods of time. For example, advertisers may insert media objects into images such as movies, television shows, streaming videos, video games, interactive media, and so forth. To increase the effectiveness of the Ads, advertisers may attempt to place the media objects within media where the media objects will be viewed by potential customers without being intrusive or detracting from the media.

Conventionally, to reduce or limit an amount that a media object may intrude and detract from the media being displayed to a potential customer via a display device, an advertiser will insert media objects at fixed locations on the display device. For example for videos, the advertiser may display banner media objects at the top or bottom of a display screen or at the corner of the display screen. However, the fix locations of the media objects on the display screen may have limited effectiveness. The fixed location of the advertisement space restricts the ability of an advertiser to display product features, provide additional information, or select advertisement insertion locations. In one example, a viewer may become accustomed to media objects being displayed at the fixed location and become desensitized or blind to media objects displayed at the fixed locations and ignore the media objects.

Additionally, depending on the image being displayed, the type of display, and/or the type of content being displayed, the media objects being displayed at the fixed location may disrupt the media being displayed to the viewer. For example, when the media is a video game, critical information, such as the number of lives a player or different objects being carried by the player, may be covered up by a banner media object located along the top or bottom of the image. When the media object covers up information of interest to the viewer, the media object may have an opposite effect than the one intended, where the viewer is annoyed and less likely to purchase the advertised good or service. Fixed advertisement locations may decrease viewership of the advertisements and attentiveness of viewers to the advertisements. Decreased viewership and viewer attentiveness may diminish a success rate of an advertisement and revenues created by the advertisements.

To avoid covering up information of interest to the view, advertisers may adjust an aspect ratio of the image to reduce a size of the image to fit within an area of the display not covered by the Ads. However, when the aspect ratio of the image is altered it, the image may become distorted or disfigured, thereby annoyed the viewer and decreasing an effectiveness of the Ad. Furthermore, for some types of display devices, such as panoramic displays, augmented-reality displays, virtual-reality displays, interactive displays, and so forth, the display devices may not have displays with the fixed location areas to display the conventional Ads.

The embodiments described herein may address the above-noted deficiencies by providing a media object insertion system to insert media objects into media. The media object insertion system may include a memory device to store data in a database, a display device to display at least a portion of panoramic media, and a processing device coupled to the memory device and the display device. The processing device may analyze panoramic media to identify a viable insertion area (VIA) within a perspective window of the panoramic media. The processing device may determine that the database includes a media object that corresponds to the dimensions of the VIA. The processing device may insert the media object onto the panoramic media at the VIA. The processing device may in response to the panoramic media ending, cease inserting the media object onto the panoramic media at the VIA. The media object insertion system may dynamically insert media objects into panoramic media to increase the ability of an advertiser to display product features, provide additional information, or select advertisement insertion locations. The media object insertion system may dynamically insert media objects into panoramic media to increase viewership of the advertisements and increase attentiveness of viewers to the advertisements.

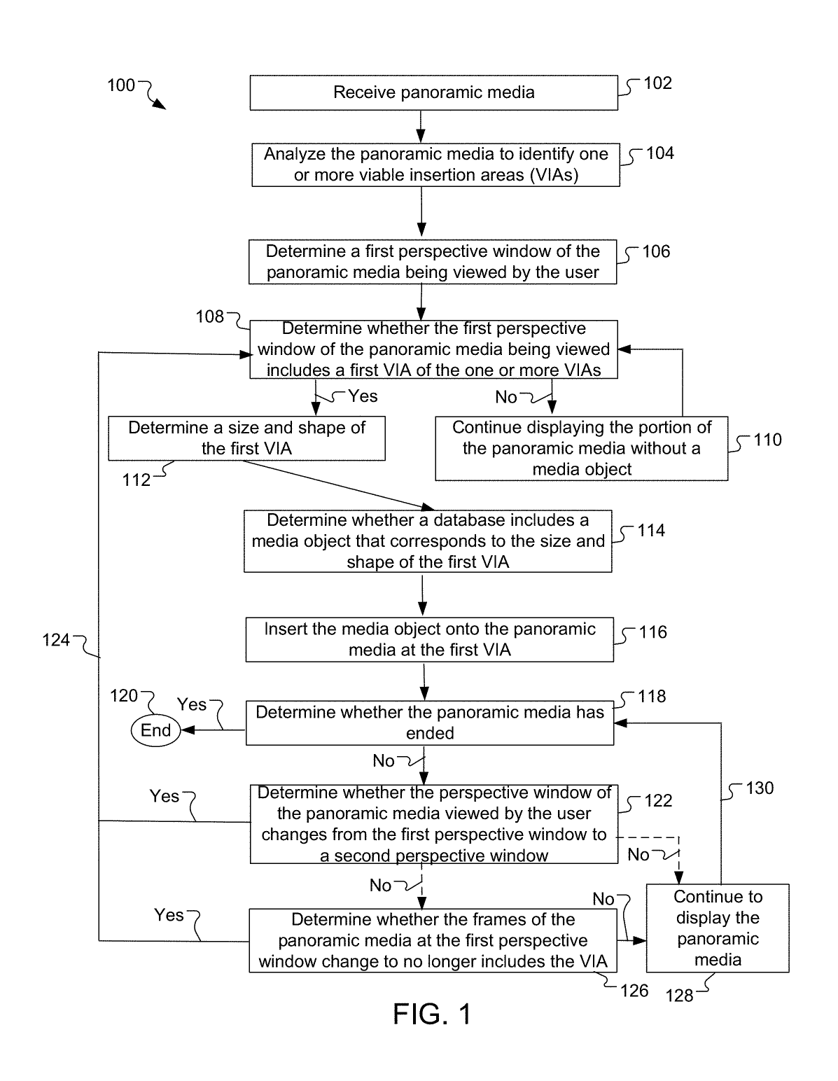

FIG. 1 illustrates a flowchart 100 for a method to insert a media object into panoramic media, according to an embodiment. The method may be performed, at least in part, by a processing device. The processing device may include one or more processors, central processing units (CPUs), integrated circuits, control units, arithmetic and logic units (ALUs), and so forth.

The method may begin with a processing device receiving panoramic media from another device (block 102). The other device may be a media source or a device to provide panoramic media from a content provider, such as a streaming media provider, a digital media provider, and so forth. In another embodiment, the content provider may be an individual desiring to view the panoramic media. For example, the individual may download the media to a display device, insert a physical media storage device (such as a DVD or VHS) into an input device of a display device, or couple a media device to the display device to provide panoramic media to the display device. In another embodiment, the panoramic media may be selected by the content provider. In another embodiment, the panoramic media may be predetermined media, such as a demonstration video or a preloaded video.

The panoramic media may include a video, a still image, a set of images, a portion of a video, and so forth. In one example, the panoramic image may be a panoramic video, a panoramic image, a virtual reality video, a virtual reality image, an augmented reality video, or an augmented reality image. In another example, the panoramic media may be a wide-angle video. In another example, the panoramic media may be an aggregate of multiple videos or video taken at multiple angles. In one example, the panoramic media may be a 360-degree video. In another example, the panoramic media may be a wide-angle video. In another example, the panoramic media may be an aggregate of multiple still images or still images taken at multiple angles. In another example, the panoramic media may be a 360-degree image. In another example, the panoramic media may be received from a content provider.

The method may include analyzing the panoramic media to identify one or more viable insertion areas (VIAs) (block 104). The media object may be an Ad, a logo, information, a video clip, an image, text, and so forth. A VIA is an area in video content for insertion of media objects into the panoramic media that does not interfere with relevant and dominant portions of the panoramic media and/or relevant and dominant objects in the panoramic media. For example, a VIA may be an area in the panoramic media that may be embedded or overlaid with non-obtrusive media objects. In one embodiment, a relevant and dominant portion of the panoramic media or object may be one or more frames in the panoramic media or objects in the panoramic media that contain scenes or objects with a threshold amount of action and/or motion. For example, panoramic media may include relevant and dominant objects or areas, such as a car driving in the scene, and non-dominant objects or areas, such as a background building, in the panoramic media.

In one embodiment, the VIA may be determined by analyzing one or more frames of the panoramic media to determine the dominant areas and the non-dominant areas. For example, the panoramic media may be analyzed to determine non-dominant areas of the panoramic media in a panoramic media window and media objects may be displayed in the non-dominant areas of the panoramic media window.

In one embodiment, a relevant and dominant object may be an object in panoramic media, such as video content, scene with one or more selected dominant criteria. The dominant criteria may include an object that exceeds a minimum threshold size, an object with movement in the video content scene that exceeds a minimum threshold movement value, an object with high detail compared to other object in the video content scene, an object with high resolution compared to other object in a video content scene, an object with selected features (such as an object that is a person), and so forth. In another embodiment, a non-dominant object may be an object in the video content scene with one or more selected non-dominant criteria. The non-dominant criteria may include an object that is below a minimum threshold size, an object with movement in a video content scene that is below a minimum threshold movement value, an object with low detail compared to another object in a video content scene, an object with low resolution compared to another object in a video content scene, an object that is blurred and/or out of focus in a video content scene, and so forth. For example, a cloud in a sky or flooring in a building may be a low detail object in a video content scene.

In another example, the panoramic media may be analyzed to determine dominant areas of the panoramic media with a perspective window and a media object may be displayed in locations other than the dominant areas of the perspective window, as discussed below. One advantage of displaying the media object in non-dominant areas of the perspective window and/or locations other than the dominant areas of the perspective window may be to enable a viewer to view the panoramic media and at the same time view media objects in non-obtrusive spots.

In one embodiment, the processing device may identify the VIAs based on one or more insertion areas rules. For example, the insertion areas rules may include the distance between the VIA and a dominant object, a size of the VIA, a distance between a VIA in a previous panoramic media scene and a current panoramic media scene, a number of panoramic media scenes a VIA is available, and so forth.

In another embodiment, the processing device may use a neural network or machine learning to identify VIAs for embedding or overlaying media object. For example, the neural network may be trained using any media with different frames or images with different scenes or environments. The media may include panoramic media, normal media (e.g. fixed within a defined frame), and so forth. In one example, an individual may manually identify VIAs within the different frames or images.

The neural network may then determine the characteristics of the manually identified VIAs and identify the same or similar characteristics within the current frames or images of the panoramic media to define the VIAs within the current panoramic media. In one example, the characteristics of the VIAs may be types of objects within a portion of the frame or image, a color of a portion of the frame or image, an amount of change in color or objects between consecutive frames or images, sizes of open areas or areas of the same or similar colors for a portion of the frame or image, a clarity level at least portion of the frame of the 360-degree video (such as whether the frame is relatively clear or blurry), a focus level of at least portion of the frame of the 360-degree video (such as whether the frame is relatively in-focus or out of focus), and so forth. The characteristics of the VIAs may define non-intrusive or non-disruptive areas in the frames or images to insert media objects.

In another embodiment, the processing device may merge or combine multiple VIAs identified within a frame or image or set of frames or images. In one example, the processing device may combine a first VIA with a second VIA that coincides at the same or similar locations. In another example, the processing device may combine a first VIA with a second VIA that overlaps or partially overlap in a location within a frame or image or set of frames or images. In another example, the processing device may combine a first VIA with a second VIA that are adjacent or substantially adjacent in location within a frame or image or set of frames or images. In another example, the processing device may define a threshold number of VIAs within a frame or image or set of frames or images and eliminate the VIAs that exceed the threshold number of VIAs. In one example, the processing device may define the 15 VIAs within a frame or image or set of frames or images as a set of VIAs that are eligible for the processing device to embed or overlay media objects onto. In another example, when the processing device identifies multiple VIAs within a frame or image or set of frames or images, the processing device may eliminate the VIAs with less desirable characteristics. The less desirable characteristics may include the dimensions of the VIAs, the location of the VIAs within the frame or image or set of frames or images, a period of time the VIA is available within the set of frames or images, and so forth.

In another embodiment, to determine the VIA, the processing device may divide the panoramic media into multiple areas. For example, the processing device may divide the panoramic media into a front area, a back area, a left area, and a right area. The number of areas is not intended to be limiting. For example, the number of areas may vary based on the dimensions of the panoramic media, a resolution level of the panoramic media, and so forth. The processing device may then analyze each area to identify VIAs within the area. For example, the processing device may identify the locations and dimensions of the VIAs and determine how long the VIAs are available in the panoramic media to overlay a media object. In one example, the processing device may divide the panoramic media into multiple areas to increase a speed and efficiency that it identifies the VIAs. In one example, the processing device may analyze each area independently. In another example, the processing device may analyze each area in parallel. In another example, different areas may be analyzed by different processing devices independently and/or in parallel.

In another embodiment, the processing device may divide the panoramic media into scenes. A scene may be a subset of frames or images included in the panoramic media. The processing device may divide the panoramic media into scenes based on scene information. The scene information may include the pixel colors of a frame or image, a background color or object of a frame or image, a threshold number of sequential frames or images, and so forth. For example, when multiple frames or images have substantially the same or similar color schemes and/or the same or similar background colors or objects, the processing device may define the frames or images as a scene.

In one embodiment, when a length of a scene is below a threshold level, the processing device may classify the scene as ineligible for embedding or overlaying media objects at VIAs. The threshold length of a scene may be as a number of frames or images, an amount of time the scene is displayed, and so forth. In one example, the number of frame or images or the amount of time they are displayed may be dynamic. For example, the threshold length of a scene may be adjusted based on a type of media object to be embedded or overlaid at the VIA. In another example, the number of frames or images or the amount of time may be fixed. For example, the threshold for a scene may be minimum of 120 frames or a minimum of three seconds of display time. In another example, a media object provider may set a minimum length of the scene for their media object.

An advertisement insertion system may be used to dynamically insert content of an advertisement into video content, such as web-based video content. In another embodiment, the advertisement insertion system may be used to customize the content of a media object based on the panoramic media the media object is inserted into. One advantage of dynamically inserting and/or customizing media objects may be to create media objects that are unique to the panoramic media. Another advantage of dynamically inserting and/or customizing media object may be to match the media objects with similar panoramic media.

The method may include determining a first perspective window of the panoramic media being viewed by the user (block 106). In one embodiment, a perspective window of the panoramic media may be a display window as defined by a field of view of a viewer of the panoramic media. In another embodiment, the perspective window of the panoramic media may be a window as defined by a size of a display screen of a display device relative to the size of the panoramic media. In another embodiment, the perspective window of the panoramic media may be a percentage of the overall display window or field of view. For example, the perspective window may be 75 percent of the overall display window or field of view.

In one example, the display device may be a television, a computer monitor, a smartphone display, a liquid crystal display (LCD) display, a light emitting diode (LED) display, and so forth. In another example, the display device may be a virtual reality display, an augmented reality display, a wearable display, a head-mounted display, a panoramic display, and so forth. The display device may be coupled to the processing device. The processing device may also be coupled to an input device. In one example, the input device may be a touch screen sensor, a mouse, a keyboard, a touchpad, and so forth. In another example, the input device may be a motion sensor, a gyroscope, an accelerometer, a three dimensional (3D) accelerometer, and so forth.

The panoramic media may be an image that is larger than a viewable region of the display device. For example, when the panoramic media is a 360-degree video, the viewer may not be able to view the entire 360-degree video at the same time. To determine the first perspective window, the panoramic media may initially be displayed at a baseline perspective window view. For example, a display device may display the image such that a center of the image is where the X-axis, Y-axis, and Z-axis are at zero degrees. To view different parts of the panoramic media, the viewer may change the perspective window that they view the panoramic media using the input device. For example, when the 360-degree video is a bird's eye view of an area, the viewer may not be able to view all of the 360-degree video that is being displayed. To view the 360-degree video from different angles or perspectives, the viewer may use the input device to change the angle or perspective that the 360-degree video is displayed to the viewer.

The method may include determining whether the first perspective window of the panoramic media being viewed includes a VIA of the one or more identified VIAs (block 108). In one example, to determine whether the first perspective window of the panoramic media being viewed includes a VIA, the processing device may compare the locations of the one or more VIA with the portion of the panoramic media shown for the first perspective window.

When the processing device determines that the portion of the panoramic media shown for the first perspective window does not include any VIAs, the processing device may continue to display the portion of the panoramic media for the first perspective window without any overlaid media objects (block 110). When the first perspective window does not include any VIAs, the processing device may continue to monitor the portion of the panoramic media for the first perspective window to determine whether subsequent images or frames of the portion of the panoramic media for the first perspective window include one or more VIAs (block 108).

When the processing device determines that the portion of the panoramic media shown for the first perspective window includes one or more VIAs, the processing device may determine the dimensions of one or more of the VIAs within the portion of the panoramic media shown for the first perspective window (block 112). In one embodiment, when the portion of the panoramic media shown for the first perspective window includes a VIA, the processing device may determine the dimensions of the VIA within the portion of the panoramic media shown for the first perspective window. In another embodiment, the processing device may determine a configuration of a display screen in determining the dimensions of the VIA. The configuration of the display screen may include the dimensions of the viewable area of the display screen, an aspect ratio of the display screen, a relative distance of the display screen from the eyes of the viewer, and so forth.

The method may include determining whether a database includes one or more media objects that correspond to the dimensions of one or more of the VIAs within the portion of the panoramic media shown for the first perspective window (block 114). In one embodiment, the processing device may determine whether a media object may be viewable to a viewer based on a configuration of the display screen. For example, when the viewable area of the display screen is relatively small, the aspect ratio of the display screen is relative low, or the display screen is a relatively far distance away from the eyes of the viewer may cause a media object embedded or overlaid at a VIA to be too small to be viewed by the viewer. In this example, while the dimensions of the media object may fit within a VIA, the VIA may not be eligible for the processing device to embed or overlay media object at the VIA.

In one example, the processing device may include a non-transitory computer readable medium or storage device, such as internal memory, with a database of media objects from one or more media object sources. In another example, the storage device may be an external storage device, such as a cloud storage device or an external server, that may store the database of media objects. In another example, different media objects may be stored at different storage devices. For example, the media object sources may be different advertisers with different media objects to insert into the panoramic media. The processing device may search one or more of the different storage devices to determine whether at least one of the storage devices includes a media object that fits the dimensions one or more of the VIAs.

In one embodiment, the database(s) may include information indicating the sizes and/or shapes of the media objects stored in the database(s). In another embodiment, the database(s) may include information indicating whether the media objects may be resized and a dimension range that they may be resized to. In one example, when the media object is a video with an original width or height that does not match a width or height of the VIA, the processing device may scale the width or height of the video to fit the width or height of the VIA. In another example, the database may include a first media object that is originally 300 pixels in width by 300 pixels in height and that may be proportionally resized in width and height within a range of 150 pixels to 900 pixels.

In another embodiment, when the database(s) includes more than one media object that may fit within the dimensions of the VIA, the database(s) may indicate a priority level of the media objects. For example, the database(s) may include two eligible media objects and may indicate that a first media object should be used when possible and the second media object should be used as a backup to the first media object. In another example, the processing device may determine a point in time when each of the media objects was last overlaid onto the panoramic media and select the media object that was last shown the longest time ago to be overlaid onto the current VIA. In another embodiment, when there are multiple VIAs and multiple eligible media objects, the processing device may overlay the multiple media objects at the multiple VIAs.

In another embodiment, when the portion of the panoramic media shown for the first perspective window includes multiple VIAs, the processing device may prioritize the multiple VIAs based on priority information and select one or more of the VIAs with the highest priority. In one example, the priority information may include: an amount of time the VIA is available for the portion of the panoramic media shown for the first perspective window; a size of the VIA; a shape of the VIA; a location of the VIA within the portion of the panoramic media shown for the first perspective window; or a location of the VIA within the portion of the panoramic media shown for the first perspective window relative to a dominant object or central object in the portion of the panoramic media shown for the first perspective window.

When the processing device has identified the VIA within the portion of the panoramic media shown for the first perspective window and the media object that corresponds to the dimensions of the VIA, the method may include the processing device inserting the media object onto the panoramic media at the identified VIA (block 116). For example, the processing device may determine a Cartesian coordinate or the X coordinate, Y coordinate, and Z coordinate of the VIA and the processing device may embed or overlay the media object at the Cartesian coordinate or the X coordinate, Y coordinate, and Z coordinate of the VIA.

In response to overlaying the media object onto the identified VIA, the method may include monitoring the panoramic media to determine whether the displaying of the panoramic media has ended (block 118). In one example, when the panoramic media is a video, the processing device may determine when the video has finished playing. In another example, when the panoramic media is for a video game, a virtual reality interface, or an augmented reality interface, the processing device may determine when the video game, the virtual reality interface, or the augmented reality interface has ended, such as when the game or interface has ended or a user pauses or ends the game or interface. In another example, a display device coupled to the processing device may finish showing the panoramic media after a defined period of time.

When the panoramic media has ended, the processing device may cease overlaying the media object at the VIA (circle 120). When the panoramic media has not ended, the processing device may determine whether the perspective window of the panoramic media viewed by the user has changed from a first perspective window to a second perspective window (block 122). In one example, to determine whether the first perspective window changed to the second perspective window, the processing device may determine whether an input from a sensor coupled to the processing device indicates that the user has changed a Cartesian coordinate or an X coordinate, a Y coordinate, or a Z coordinate of the perspective window the user is viewing the panoramic media. In one example, the input may indicate a movement of a cursor on a display screen, a movement of the user, a movement of the display screen, a voice command, or other input information indicating the change to the X coordinate, the Y coordinate, and/or the Z coordinate of the perspective window of the user. In another example, to change from the first perspective window to the second perspective window, the X coordinate, the Y coordinate, and/or the Z coordinate must change by a threshold amount. For example, the threshold amount may be at least a 5 degree change along the X axis, the Y axis, or the Z axis.

When the first perspective window has changed to the second perspective window, the method may include returning to block 108 to determine whether the second perspective window includes one or more VIAs (arrow 124). In one embodiment, when the first perspective window has not changed to the second perspective window, the processing device may continue to display the panoramic media with the overlaid media object via the display device (block 128).

In another embodiment, when the first perspective window has not changed to the second perspective window, the method may include determining whether the frames of the portion of the panoramic media for the first perspective window no longer include an eligible VIA (block 126). When the frames of the portion of the panoramic media for the first perspective window no longer include an eligible VIA, the method may include returning to block 108 to determine whether the second perspective window includes one or more VIAs to insert the same media object or a different media object as a different VIA (arrow 124). When the frames of the portion of the panoramic media for the first perspective window continue to include the VIA, the processing device may continue to display the panoramic media with the overlaid media object via the display device (block 128). As the processing device continues to display the panoramic media, the processing device may return to block 118 of the method to repetitively determine whether the panoramic media has ended, the first perspective window has changed to the second perspective window, or if the panoramic media still includes the VIA (arrow 130).

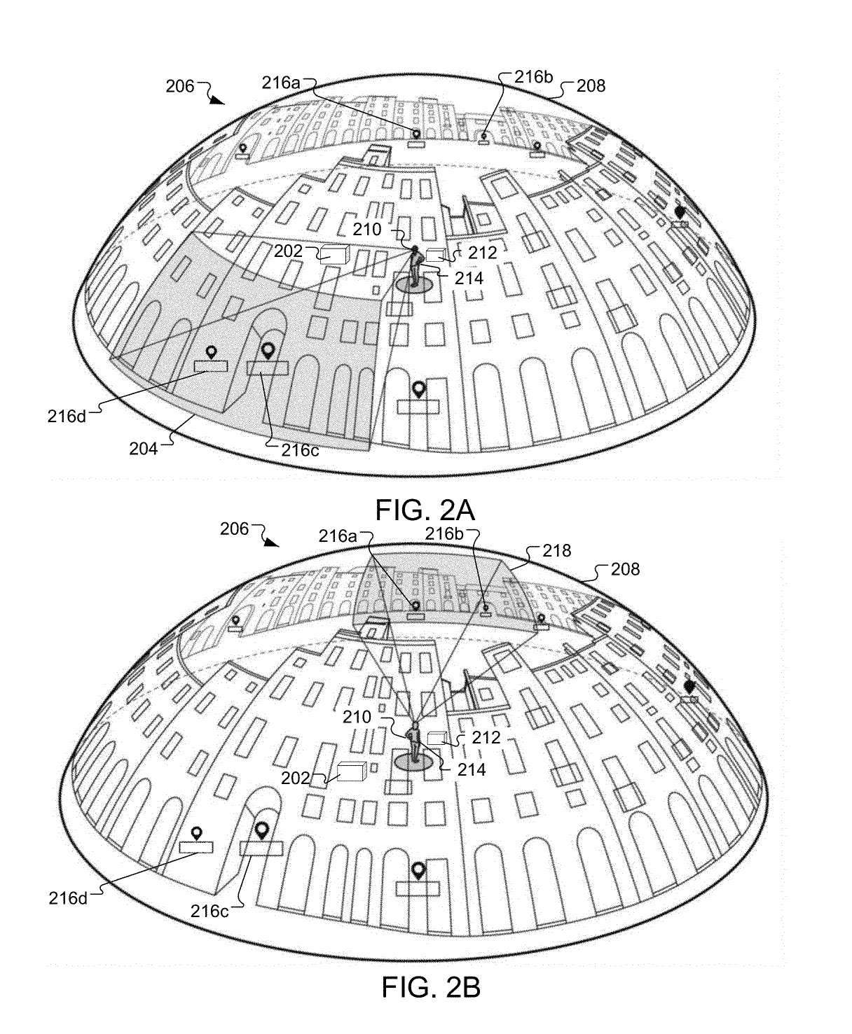

FIG. 2A illustrates a panoramic display device 202 displaying a first perspective window 204 of panoramic media 206, according to an embodiment. In one embodiment, the panoramic display device 202 may be a projector device that may project the panoramic media 206 on a projection surface 208. In one example, the projection surface 208 may be a dome that at least partially surrounds a viewer 210. In this example, the projection surface 208 may surround the viewer 210 to provide a virtual reality display or an augmented reality display. In one example, the panoramic display device 202 may be located at a base or ground level of the projection surface 208, such as along the ground at a center of the dome. In another example, the panoramic display device 202 may be located a top of the projection surface 208, such as at a top center of the dome. In another example, the panoramic display device 202 may include multiple projectors. In another example, the panoramic display device 202 may be a curved display screen that may at least partially surround the viewer 210. For example, the panoramic display device 202 may be one or more curved liquid crystal display (LCD) screens or curved light emitting diode (LED) screens. As discussed above, a first sensor 212 and/or a second sensor 214 may determine where the viewer 210 is viewing the panoramic media 206. The panoramic display device 202 or a processing device coupled to the panoramic display device 202 may use measurement information to define the first perspective window 204.

As discussed above, the panoramic media 206 may include one or more VIAs. For example, the panoramic media 206 may include VIAs 216a-216d. The VIAs may be located inside the first perspective window 204 and outside the first perspective window 204. For example, the first VIA 216a may be located outside the first perspective window 204 at a portion of the panoramic media 206 behind a field of view of the viewer 210. In another example, the second VIA 216b may be located outside the first perspective window 204 at a portion of the panoramic media 206 behind the field of view of the viewer 210. In another example, the third VIA 216c may be located within the first perspective window 204 at a first location of the panoramic media 206 within the first perspective window 204. In another example, the fourth VIA 216d may be located within the first perspective window 204 at a second location of the panoramic media 206 within the first perspective window 204. As discussed above, media objects may be overlaid onto the panoramic media 206 at the third VIA 216c and/or the fourth VIA 216d.

FIG. 2B illustrates a panoramic display device 202 displaying a second perspective window 218 of the panoramic media 206, according to an embodiment. Some of the features in FIG. 2B are the same or similar to some of the features in FIG. 2A as noted by same reference numbers, unless expressly described otherwise. The second perspective window 218 may be a different portion of the panoramic media 206 than the first perspective window 204 in FIG. 2A. To view the second perspective window 218, the viewer 210 may turn around to see a portion of the panoramic media 206 previously located behind him or her in FIG. 2A. As the viewer 210 turns around, the first sensor 212 and/or the second sensor 214 may determine a change in where the viewer is looking along an X axis, a Y axis, and/or a Z axis of the panoramic media 206. The panoramic display device 202 or a processing device coupled to the panoramic display device 202 may define the second perspective window 218 using measurement information from the first sensor 212 and/or the second sensor 214 indicating the change of location where the viewer is looking along the X axis, the Y axis, and/or the Z axis of the panoramic media 206. The panoramic display device 202 or a processing device coupled to the panoramic display device 202 may determine that the first VIA 216a is located within the second perspective window 218 and overlay a media object at the first VIA 216a.

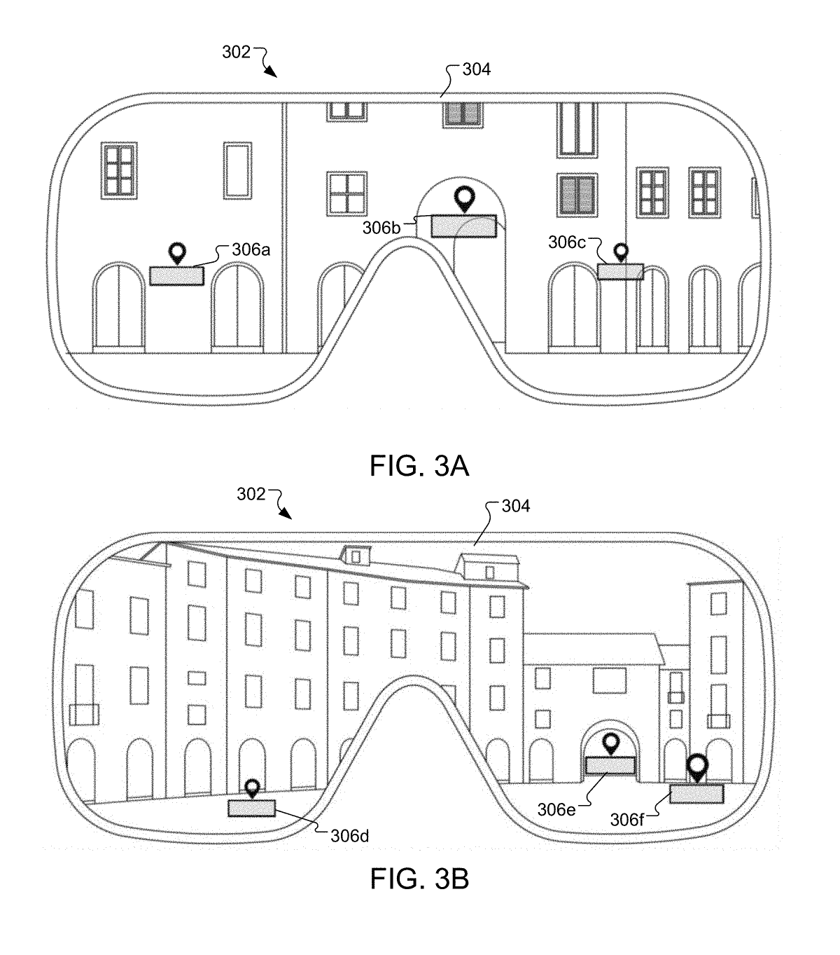

FIG. 3A illustrates a head-mounted display device 302 displaying a first perspective window of panoramic media 304, according to an embodiment. In one embodiment, the head-mounted display device 302 may be a wearable device that may be placed on the head of an individual. For example, the head-mounted display device 302 may be a smart glasses that include a processing device and a display screen. As discussed above, the processing device may identify a portion of panoramic media to display to a viewer via the display screen. In one example, the display screen may be a single display screen that displays a single image to both eyes of the viewer. In another example, the display screen may include multiple screens, such as a first display screen to show a first image to left eye of the viewer and a second display screen to show a second image to right eye of the viewer. The panoramic media displayed on the display screen may be part of a virtual reality environment, an augmented reality environment, a video game environment, a movie, a television show, and so forth.

In one embodiment, the display screen may cover a portion of the field of view of the viewer. In another embodiment, the display screen may surround approximately all of the field of view of the viewer. In one example, the display screen may be a curved display screen that may curve around the field of view of the viewer to cover the field of view of the viewer with a portion of the panoramic media. In another example, the display screen may be one or more curved liquid crystal display (LCD) screens or curved light emitting diode (LED) screens. As discussed above, head-mounted display device 302 may include one or more sensors coupled to the processing device. The processing device may use data from the one or more sensors to determine where the viewer is viewing the panoramic media 304. The processing device may use measurement information to define a first perspective window.

As discussed above, the panoramic media 304 may include one or more VIAs. For example, the first perspective window of the panoramic media 304 may include a first VIA 306a, a second VIA 306b, a third VIA 306c. The first VIA 306a may be located at a bottom left of the first perspective window. The second VIA 306b may be located at middle of the first perspective window. The third VIA 306b may be located at a bottom right of the first perspective window. As discussed above, media objects may be overlaid onto the panoramic media 304 at the first VIA 306a, the second VIA 306b, and/or the third VIA 306c.

FIG. 3B illustrates a head-mounted display device 302 displaying a second perspective window of panoramic media 304, according to an embodiment. Some of the features in FIG. 3B are the same or similar to some of the features in FIG. 3A as noted by same reference numbers, unless expressly described otherwise. The second perspective window may be a different portion of the panoramic media 304 than the first perspective window in FIG. 3A. For example, to view the second perspective window, the viewer may turn around to see a portion of the panoramic media 304 previously located behind him or her in FIG. 3A.

As the viewer turns around, the sensors may determine a change in where the viewer is looking along an X axis, a Y axis, and/or a Z axis of the panoramic media 304. The processing device of the head-mounted display device 302 may define the second perspective window using measurement information from the sensors indicating the change of location where the viewer is looking along the X axis, the Y axis, and/or the Z axis of the panoramic media 304. The processing device of the head-mounted display device 302 may determine that a fourth VIA 306d, a fifth VIA 306e, and a sixth VIA 306f is located within the second perspective window and overlay media objects at the fourth VIA 306d, the fifth VIA 306e, and/or the sixth VIA 306f.

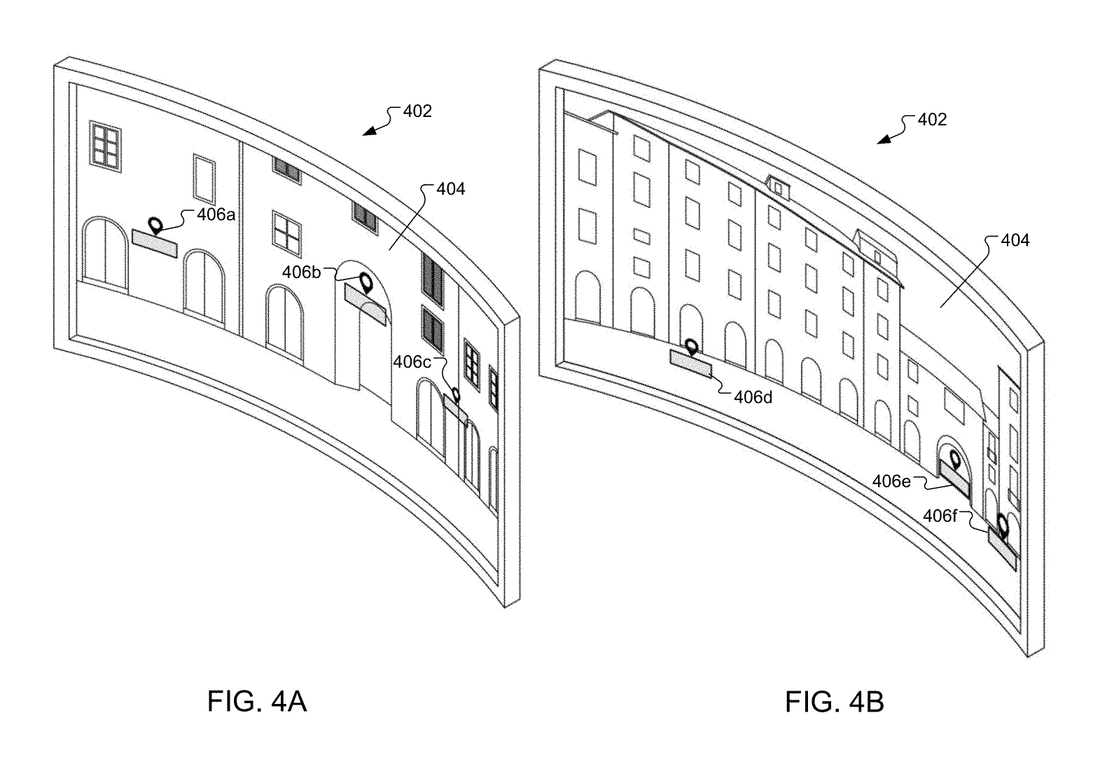

FIG. 4A illustrates a display device 402 displaying a first perspective window of panoramic media 404, according to an embodiment. In one embodiment, the display device 402 includes a processing device and a display screen. In one example, the display screen may be a television, a computer screen, a monitor, a flat screen, a curved screen, an LED display screen, an LCD display screen, and so forth. The processing device may identify a portion of panoramic media to display to a viewer via the display screen. In one example, the display screen may be a single screen that displays a single image to both eyes of the viewer. In another example, the display screen may include multiple screens, such as a first display screen to show a first image to left eye of the viewer and a second display screen to show a second image to right eye of the viewer. In another example, the display screen may be divided into two areas to display a first image to the viewer in the first area and a second image to the viewer in the second area. The panoramic media 404 displayed on the display screen may be part of a virtual reality environment, an augmented reality environment, a video game environment, a movie, a television show, and so forth.

The display screen may cover at least portion of the field of view of the viewer. In one example, the display screen may be a flat display screen that may display a portion of the panoramic media 404. In one example, the display screen may be a curved display screen that may curve around at least a portion of a field of view of the viewer to cover at least a portion of the field of view of the viewer with a portion of the panoramic media. As discussed above, display device 402 may include one or more sensors coupled to the processing device. The processing device may use data from the one or more sensors to determine what portion of the panoramic media 404 the viewer is viewing. The processing device may use measurement information that indicates the portion of the panoramic media 404 that the viewer is viewing to define a first perspective window.

As discussed above, the panoramic media 404 may include one or more VIAs. For example, the first perspective window of the panoramic media 404 may include a first VIA 406a, a second VIA 406b, and a third VIA 406c. The first VIA 406a may be located at a left side of the first perspective window, the second VIA 406b may be located at a middle of the first perspective window, and the third VIA 406b may be located at a right side of the first perspective window. As discussed above, media objects may be overlaid onto the panoramic media 404 at the first VIA 406a, the second VIA 406b, and/or the third VIA 406c.

FIG. 4B illustrates the display device 402 displaying a second perspective window of the panoramic media 404, according to an embodiment. Some of the features in FIG. 4B are the same or similar to some of the features in FIG. 4A as noted by same reference numbers, unless expressly described otherwise. The second perspective window may be a different portion of the panoramic media 404 than the first perspective window in FIG. 4A. To view the second perspective window, the viewer may use a sensor to see a portion of the panoramic media 404 previously located behind him or her in FIG. 4A.

As the viewer uses the sensor to see a different portion of the panoramic media, the sensors may determine a change in where the viewer is looking along an X axis, a Y axis, and/or a Z axis of the panoramic media 404. The processing device of the display device 402 may define the second perspective window using measurement information from the sensors indicating the change of location where the viewer is looking along the X axis, the Y axis, and/or the Z axis of the panoramic media 404. The processing device of the display device 402 may determine that a fourth VIA 406d, a fifth VIA 406e, and a sixth VIA 406f is located within the second perspective window. The processing device of the display device 402 may overlay media objects at the fourth VIA 406d, the fifth VIA 406e, and/or the sixth VIA 406f. The number, location, and dimensions of the VIAs in FIGS. 2A, 2B, 3A, 3B, 4A, and 4B are not intended to be limiting. For example, different panoramic media may include different numbers of VIAs at different locations and with different dimensions.

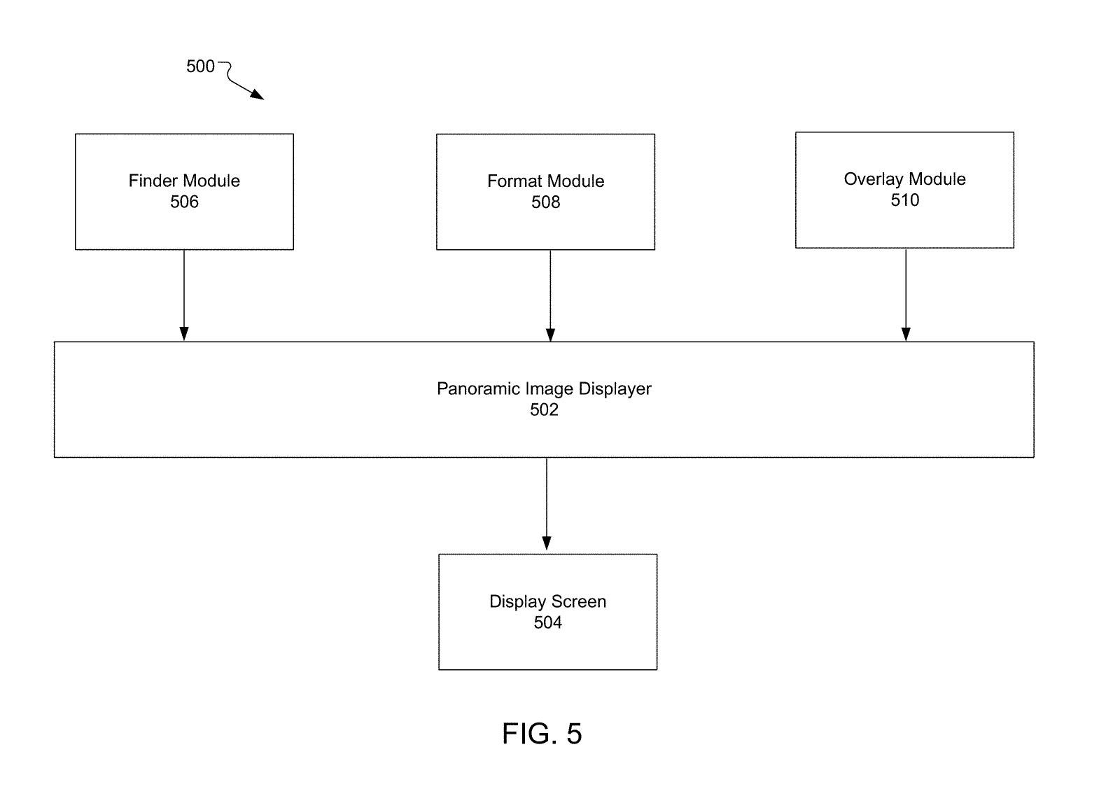

FIG. 5 illustrates an advertisement insertion system 500 for inserting a media object into panoramic media, according to an embodiment. In one embodiment, the advertisement insertion system 500 may include panoramic media displayer 502, such as a video player, to show panoramic media in a perspective window of a display screen 504. In one embodiment, the panoramic media may contain non-obtrusive media objects embedded in the panoramic media. The panoramic media displayer 502 may receive media object insertion information and/or customization information from several modules including a finder module 506, a format module 508, or an overlay module 510. The advertisement insertion system 500 may enable an advertiser to dynamically insert media objects into VIAs of panoramic media to enable a viewer of view the panoramic media and enable the advertiser to insert media objects into the panoramic media. The inserted media objects may be adapted for the panoramic media to reduce or eliminate obstructing the panoramic media while displaying the media objects.

The media objects may be formatted as video content, web 3D objects, static images, animated images, and so forth. In another embodiment, the advertisement insertion system 500 may overlay the media objects onto the panoramic media. In one embodiment, the advertisement insertion system 500 may dynamically overlay media objects onto the panoramic media at VIAs based on advertiser preferences. In one embodiment, the finder module 506 may find a media object in a database. In another embodiment, the format module 508 may format a media object to the dimensions of a VIA. The overlay module 510 may overlay the media object onto the panoramic media being displayed by the panoramic media displayer 502.

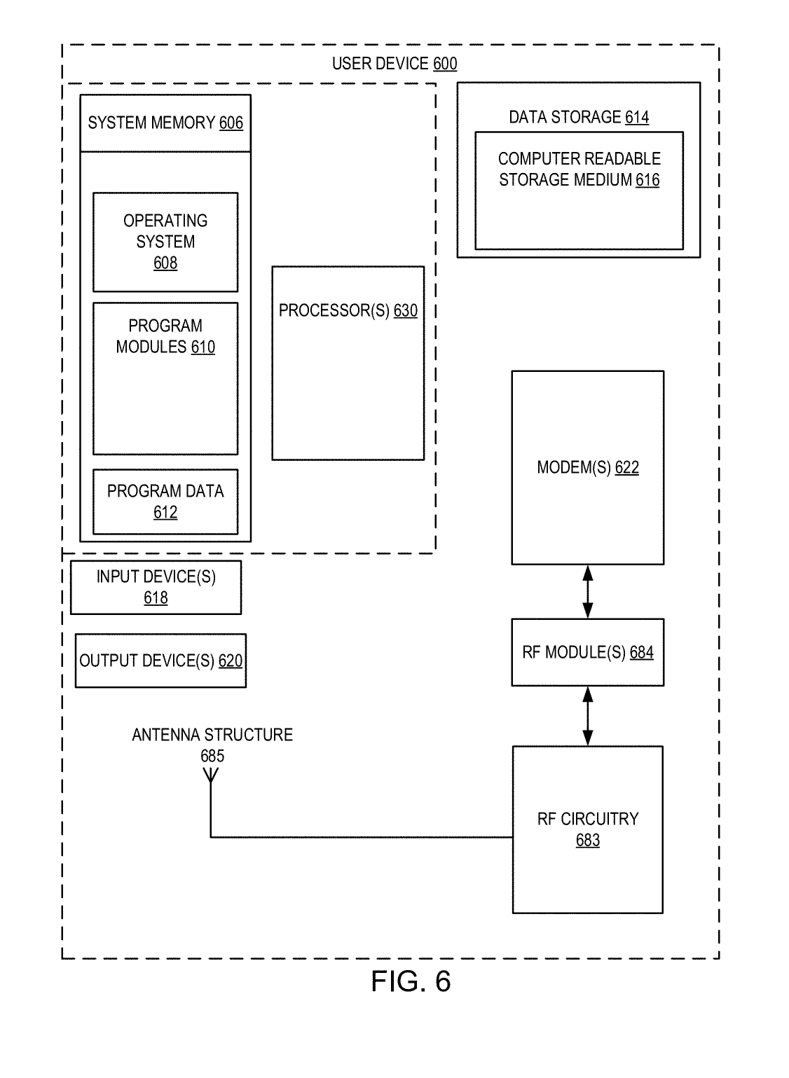

FIG. 6 is a block diagram of a user device 600 in which embodiments of the user device 600 may be implemented for the media object insertion system, according to an embodiment. The user device 600 may correspond to the devices discussed in FIGS. 1, 2A, 2B, 3A, 3B, 4A, 4b, and 5. The user device 600 may be any type of computing device such as an electronic book reader, a PDA, a mobile phone, a laptop computer, a portable media player, a tablet computer, a camera, a video camera, a netbook, a desktop computer, a gaming console, a DVD player, a computing pad, a media center, and the like. The user device 600 may be any portable or stationary user device. For example, the user device 600 may be an intelligent voice control and speaker system. Alternatively, the user device 600 may be any other device used in a WLAN network (e.g., Wi-Fi® network), a WAN network, or the like.

The user device 600 includes one or more processing device(s) 630, such as one or more CPUs, microcontrollers, object programmable gate arrays, or other types of processing devices. The user device 600 also includes system memory 606, which may correspond to any combination of volatile and/or non-volatile storage mechanisms. The system memory 606 stores information that provides operating system component 608, various program modules 610, program data 612, and/or other components. In one embodiment, the system memory 606 stores instructions methods as described herein. The user device 600 performs functions by using the processing device(s) 630 to execute instructions provided by the system memory 606.

The user device 600 also includes a data storage device 614 that may be composed of one or more types of removable storage and/or one or more types of non-removable storage. The data storage device 614 includes a computer-readable storage medium 616 on which is stored one or more sets of instructions embodying any of the methodologies or functions described herein. Instructions for the program modules 610 may reside, completely or at least partially, within the computer-readable storage medium 616, system memory 606 and/or within the processing device(s) 630 during execution thereof by the user device 600, the system memory 606 and the processing device(s) 630 also constituting computer-readable media. The user device 600 may also include one or more input devices 618 (keyboard, mouse device, specialized selection keys, etc.) and one or more output devices 620 (displays, printers, audio output mechanisms, etc.).

The user device 600 further includes modem 622 to allow the user device 600 to communicate via a wireless network(s) (e.g., such as provided by the wireless communication system) with other computing devices, such as remote computers, an item providing system, and so forth. The modem 622 may be connected to zero or more RF modules 684. The zero or more RF modules 684 may be connected to RF circuitry 683. The RF modules 684 and/or the RF circuitry 683 may be a WLAN module, a WAN module, PAN module, or the like. The modem 622 allows the user device 600 to handle both voice and non-voice communications (such as communications for text messages, multimedia messages, media downloads, web browsing, etc.) with a wireless communication system. The modem 622 may provide network connectivity using any type of mobile network technology including, for example, cellular digital packet data (CDPD), general packet radio service (GPRS), EDGE, universal mobile telecommunications system (UMTS), 1 times radio transmission technology (1×RTT), evaluation data optimized (EVDO), high-speed downlink packet access (HSDPA), Wi-Fi® technology, Long Term Evolution (LTE) and LTE Advanced (sometimes generally referred to as 4G), etc.

The modem 622 may generate signals and send these signals to the antenna structure 685 via the RF modules 684 and the RF circuitry 683 as described herein. User device 600 may additionally include a WLAN module, a GPS receiver, a PAN transceiver and/or other RF modules.

In one embodiment, the user device 600 establishes a first connection using a first wireless communication protocol, and a second connection using a different wireless communication protocol. The first wireless connection and second wireless connection may be active concurrently, for example, if a user device is downloading a media item from a server (e.g., via the first connection) and transferring a file to another user device (e.g., via the second connection) at the same time. Alternatively, the two connections may be active concurrently during a handoff between wireless connections to maintain an active session (e.g., for a telephone conversation). Such a handoff may be performed, for example, between a connection to a WLAN hotspot and a connection to a wireless carrier system. In one embodiment, the first wireless connection is associated with a first resonant mode of an antenna structure that operates at a first frequency band and the second wireless connection is associated with a second resonant mode of the antenna structure that operates at a second frequency band. In another embodiment, the first wireless connection is associated with a first antenna element and the second wireless connection is associated with a second antenna element. In other embodiments, the first wireless connection may be associated with a media purchase application (e.g., for downloading electronic books), while the second wireless connection may be associated with a wireless media object hoc network application. Other applications that may be associated with one of the wireless connections include, for example, a game, a telephony application, an Internet browsing application, a file transfer application, a global positioning system (GPS) application, and so forth.

Though modem 622 is shown to control transmission and reception via the antenna structure 685, the user device 600 may alternatively include multiple modems, each of which is configured to transmit/receive data via a different antenna and/or wireless transmission protocol.

The user device 600 delivers and/or receives items, upgrades, and/or other information via the network. For example, the user device 600 may download or receive items from an item providing system. The item providing system receives various requests, instructions and other data from the user device 600 via the network. The item providing system may include one or more machines (e.g., one or more server computer systems, routers, gateways, etc.) that have processing and storage capabilities to provide the above functionality. Communication between the item providing system and the user device 600 may be enabled via any communication infrastructure. One example of such an infrastructure includes a combination of a wide area network (WAN) and wireless infrastructure, which allows a user to use the user device 600 to purchase items and consume items without being tethered to the item providing system via hardwired links. The wireless infrastructure may be provided by one or multiple wireless communications systems, such as one or more wireless communications systems. One of the wireless communication systems may be a wireless local area network (WLAN) hotspot connected to the network. The WLAN hotspots may be created by products based on IEEE 802.11x standards for the Wi-Fi® technology by Wi-Fi® Alliance. Another of the wireless communication systems may be a wireless carrier system that may be implemented using various data processing equipment, communication towers, etc. Alternatively, or in addition, the wireless carrier system may rely on satellite technology to exchange information with the user device 600.

The communication infrastructure may also include a communication-enabling system that serves as an intermediary in passing information between the item providing system and the wireless communication system. The communication-enabling system may communicate with the wireless communication system (e.g., a wireless carrier) via a dedicated channel, and may communicate with the item providing system via a non-dedicated communication mechanism, e.g., a public Wide Area Network (WAN) such as the Internet.

The user device 600 are variously configured with different functionality to enable consumption of one or more types of media items. The media items may be any type of format of digital content, including, for example, electronic texts (e.g., eBooks, electronic magazines, digital newspapers, etc.), digital audio (e.g., music, audible books, etc.), digital video (e.g., movies, television, short clips, etc.), images (e.g., art, photographs, etc.), and media content. The user device 600 may include any type of content rendering devices such as electronic book readers, portable digital assistants, mobile phones, laptop computers, portable media players, tablet computers, cameras, video cameras, netbooks, notebooks, desktop computers, gaming consoles, DVD players, media centers, and the like.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “inducing,” “parasitically inducing,” “radiating,” “detecting,” determining,” “generating,” “communicating,” “receiving,” “disabling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present invention as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

The disclosure above encompasses multiple distinct embodiments with independent utility. While these embodiments have been disclosed in a particular form, the specific embodiments disclosed and illustrated above are not to be considered in a limiting sense as numerous variations are possible. The subject matter of the embodiments includes the novel and non-obvious combinations and sub-combinations of the various elements, features, functions and/or properties disclosed above and inherent to those skilled in the art pertaining to such embodiments. Where the disclosure or subsequently filed claims recite “a” element, “a first” element, or any such equivalent term, the disclosure or claims is to be understood to incorporate one or more such elements, neither requiring nor excluding two or more such elements.

Applicant(s) reserves the right to submit claims directed to combinations and sub-combinations of the disclosed embodiments that are believed to be novel and non-obvious. Embodiments embodied in other combinations and sub-combinations of features, functions, elements and/or properties may be claimed through amendment of those claims or presentation of new claims in the present application or in a related application. Such amended or new claims, whether they are directed to the same embodiment or a different embodiment and whether they are different, broader, narrower or equal in scope to the original claims, are to be considered within the subject matter of the embodiments described herein.

1. A method, comprising:
receiving panoramic media from a media source;
analyzing the panoramic media to identify one or more viable insertion areas (VIAs) within the panoramic media;
determining a first perspective window of the panoramic media being viewed by a user;
determining whether the first perspective window of the panoramic media includes a first VIA;
in response to the first perspective window of the panoramic media including the first VIA, determining a size and a shape of the first VIA;
determining whether a database includes a first media object that corresponds to the size and the shape of the first VIA;
inserting the first media object onto the panoramic media at the first VIA;
determining whether the panoramic media has ended; and
in response to the panoramic media ending, cease inserting the first media object onto the panoramic media at the first VIA.

2. The method of claim 1, further comprising, in response to the first perspective window of the panoramic media not including the first VIA, displaying the panoramic media without the first media object.

3. The method of claim 1, further comprising in response to the panoramic media not ending, determining whether the first perspective window of the panoramic media viewed by the user has changed from the first perspective window to a second perspective window.

4. The method of claim 3, in response to the perspective window changing from the first perspective window to the second perspective window:
determining whether the second perspective window of the panoramic media includes a second VIA;
in response to the second perspective window of the panoramic media including the second VIA, determining a size and a shape of the second VIA;
determining whether the database includes a second media object that corresponds to the size and the shape of the second VIA;
inserting the second media object onto the panoramic media at the second VIA;
determining whether the panoramic media has ended; and
in response to the panoramic media ending, ceasing inserting the second media object onto the panoramic media at the second VIA.

5. The method of claim 3, in response to the perspective window not changing from the first perspective window to the second perspective window, determining whether the first perspective window no longer includes the first VIA.

6. The method of claim 5, in response to the first perspective window continuing to include the first VIA, continuing to display the first perspective window of the panoramic media with the first media object.

7. The method of claim 6, in response to the first perspective window no longer including the first VIA:
determining whether the first perspective window of the panoramic media includes a third VIA;
in response to the first perspective window of the panoramic media including the third VIA, determining a size and a shape of the third VIA;
determining whether the database includes a third media object that corresponds to the size and the shape of the third VIA;
inserting the third media object onto the panoramic media at the third VIA;
determining whether the panoramic media has ended; and
in response to the panoramic media ending, ceasing inserting the third media object onto the panoramic media at the third VIA.

8. The method of claim 1, further comprising:
in response to the panoramic media not ending, determining that the first perspective window of the panoramic media viewed by the user has not changed from the first perspective window to a second perspective window; and
continuing to display the first perspective window of the panoramic media with the first media object.

9. The method of claim 1, wherein the panoramic media is a 360-degree video, a 360-degree image, a panoramic video, a panoramic image, a virtual reality video, a virtual reality image, an augmented reality video, or an augmented reality image.

10. The method of claim 1, wherein the first media object is at least one of an advertisement, a logo, a video clip, an image, or text.

11. An apparatus comprising:
a memory device to store data in a database;
a display device to display at least a portion of panoramic media;
a processing device coupled to the memory device and the display device, the processing device to:
analyze a 360-degree video to identify a first viable insertion area (VIA) within a first perspective window of the 360-degree video;
determine that the database includes a first media object that corresponds to dimensions of the first VIA;
insert the first media object onto the 360-degree video at the first VIA; and
in response to the 360-degree video ending, cease inserting the first media object onto the 360-degree video at the first VIA.

12. The apparatus of claim 11, wherein the processing device is further to:
analyze the 360-degree video to identify a second VIA within the first perspective window of the 360-degree video;
determine that the database includes a second media object that corresponds to dimensions of the second VIA;
insert the second media object onto the 360-degree video at the second VIA; and
in response to the 360-degree video ending, cease inserting the second media object onto the 360-degree video at the second VIA.

13. The apparatus of claim 11, wherein to identify the first VIA within the first perspective window of the 360-degree video, the processing device is further to initiate a neural network to identify first VIA, wherein the neural network identifies the first VIA based on training using media with different frames or images with different scenes or environments.

14. The apparatus of claim 13, wherein the training comprises previously identifying one or more characteristics of one or more identified VIAs and identifying the same or similar characteristics within current frames or images of the 360-degree video to define the VIAs within the current 360-degree video.

15. The apparatus of claim 13, wherein the one or more characteristics comprise at least one of:
a type of object within at least portion of a frame of the 360-degree video;
a color within at least portion of the frame of the 360-degree video;
an amount of change in color or objects between consecutive within at least portion of the frame of the 360-degree video; or
a size of an open area of the same or similar colors within at least portion of the frame of the 360-degree video;
a clarity level at least portion of the frame of the 360-degree video; or
a focus level at least portion of the frame of the 360-degree video.

16. The apparatus of claim 11, wherein:
the display device is a head-mounted display, and
the 360-degree video is for an augmented reality environment or a virtual reality environment.

17. A non-transitory computer-readable medium to store executive instructions stored thereon that, when executed by a processing device, cause the processing device to:
analyze panoramic media to identify a viable insertion area (VIA) within a perspective window of the panoramic media;
determine whether a database includes a media object that corresponds to dimensions of the VIA;
insert the media object onto the panoramic media at the VIA;
determine whether the panoramic media has ended; and
in response to the panoramic media ending, cease inserting the media object onto the panoramic media at the VIA.

18. The non-transitory computer-readable medium of claim 17, wherein the perspective window of the panoramic media is a window as defined by a field of view of a viewer of the panoramic media.

19. The non-transitory computer-readable medium of claim 17, wherein the perspective window of the panoramic media is a window as defined by a size of a display screen of a display device relative to the size of the panoramic media.

20. The non-transitory computer-readable medium of claim 17, wherein to insert the media object onto the panoramic media at the VIA, the processing device is further to overlay the media object onto the panoramic media at the VIA.
